(19) United States
(12) Patent Application Publication
(10) Pub. No.: US 2005/0198666 A1
(43) Pub. Date: Sep. 8, 2005

(54) System and method for controlling favorite television channels with a single knob

(76) Inventor: Kuan-Hong Hsieh, Tu-chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/071,387

(22) Filed: Mar. 2, 2005

(30) Foreign Application Priority Data
Mar. 2, 2004 (TW) 93105383

(51) Int. Cl. G06F 13/00; G06F 3/00; H04N 5/445

(52) U.S. Cl. 725/46; 725/45; 725/38

(57) ABSTRACT

A system for controlling favorite television channels with a single knob includes a knob (10), a control apparatus (11) and a television tuner (12). The knob can be rotated and pressed, and generates rotation signals and press signals which can be received by the control apparatus. The control apparatus generates channel-tuning signals, and automatically selects and sets favorite channels according to the rotation signals and press signals. The channel-tuning signals include signals that control the television tuner to tune to favorite channels and to non-favorite channels. The television tuner is used for tuning television channels according to the channel-tuning signals. A related method for controlling favorite television channels with a single knob is also disclosed.

### BACKGROUND OF THE INVENTION

1. Field of the Invention

The present invention relates to systems and methods for controlling television channels, and particularly to a system and method which can control favorite television channels with a single knob.

2. Background of the Invention

Television is perhaps the main electronic medium through which people can know about the outside world and relax at the same time, and greatly influences many people's lives. With the ongoing development of television technology, especially with the advent of satellite television and cable television, viewers now have more choices and can tune to more channels than before. Everyone has his/her own interests, and many or even most viewers tend to focus on particular channels. Many viewers want to quickly tune to their favorite channels when watching television. In bygone days, viewers used a tuner button to sequentially tune to channels one by one until they found the desired channel. More recently, viewers have been using remote control devices to tune to particular channels whose channel numbers they remember. Those two manual means for tuning to channels are unduly time-consuming. Further, viewers using remote control devices are liable to forget the correct numbers of their favorite television channels.

These problems have been largely solved with the advent of so-called favorite technology in television. With favorite technology, a viewer can preset a number of channels as his/her favorite channels, and directly tune to such favorite channels without the need for sequentially tuning to channels one by one or remembering channel numbers. However, presetting favorite channels is itself a manual operation that can be unduly time-consuming. Furthermore, the operation has to be repeated each time the viewer wants to preset a new favorite channel or remove a channel that is no longer favored.

Moreover, the usual means for invoking favorite technology is to add buttons to the television set or to the remote control device. Non-favorite channels are generally controlled using other buttons. The multiplicity of buttons uses up excessive materials and leads to oversized remote control devices.

What is needed is a system and/or method which can overcome the above-described problems.

### SUMMARY OF THE INVENTION

Accordingly, a main objective of the present invention is to provide a system and method for controlling favorite television channels with a single knob, which can tune favorite and non-favorite channels, update viewing records, automatically select favorite channels, and automatically set or delete favorite channels.

To accomplish the above objective, a system for controlling favorite television channels with a single knob (“the system”) in accordance with a preferred embodiment of the present invention is disclosed herein. The system includes a knob, a control apparatus, and a television tuner. The knob is used for performing of press and rotational operations by users, and generates corresponding press signals and rotation signals. The knob includes an operation part for performing the press and rotational operations, and a circuit for generating corresponding press signals and rotation signals. A rotation signal includes a rotational direction signal and a rotation range signal. The rotation range signal is generated according to a number of continuous rotation pulses which indicate a range of a rotational operation. When the number of the continuous rotation pulses generated by the circuit is greater than or equal to a predetermined number of rotation pulses, the rotation range is regarded as a large one; otherwise, the rotation range is regarded as a small one.

The control apparatus is used for generating corresponding channel-tuning signals and selecting favorite channels automatically according to the rotation signals, and setting or deleting favorite channels automatically according to the press signals. The control apparatus includes a plurality of Input/Output (I/O) ports, a counter, a timer, a Random Access Memory (RAM), and a Central Processing Unit (CPU). The I/O ports are used for receiving press signals and rotation signals, and for outputting channel-tuning signals. The counter is used for counting a number of continuous rotation pulses. The timer is used for timing a viewing time of a current channel. The RAM is used for storing: a channel list; viewing records of channels in the channel list; a sequence of the channels according to their viewing records; and a plurality of predetermined parameters. The channel list includes channel identifiers and favoritism identifiers of channels. The predetermined parameters include a predetermined number of pulses, a predetermined viewing time, and a predetermined parameter that is used for determining whether a channel is included in automatically selected favorite channels. The CPU is used for updating the viewing records of channels according to the rotation signals, determining the rotational direction and rotation range and generating corresponding channel-tuning signals, automatically selecting favorite channels according to the viewing records, and automatically setting or deleting favorite channels according to the press signals. The television tuner is used for tuning the channels according to the channel-tuning signals generated by the control apparatus.

Further, the present invention provides a method for controlling favorite television channels with a single knob, the method comprising the steps of: (a) receiving a signal from a knob; (b) determining whether the knob signal is a press signal or a rotation signal; (c) automatically setting or deleting a favorite channel by modifying the favoritism identifier of a current channel if the knob signal is a press one; (d) updating viewing records and a sequence of channels if the knob signal is a rotation one; (e) determining a rotational direction; (f) determining whether a rotation range of the knob is large or small if the rotational direction is counter-clockwise; (g) tuning to an immediately preceding favorite channel according to the viewing records and favoritism identifiers of channels if the rotation range is large; (h) tuning to an immediately preceding channel if the rotation range is small; (i) determining whether the rotation range of the knob is large or small if the rotational direction is clockwise; j) tuning to a next favorite channel according to the viewing records and favoritism identifiers of channels if the rotation range is large; and (k) tuning to a next channel if the rotation range is small.

In summary, the system and method of the present invention can tune favorite and non-favorite channels according to operations of a single knob, update viewing records of channels, automatically select top viewed channels as favorite channels, and automatically set and delete favorite channels according to operations of the knob.

Other objects, advantages and novel features of the present invention will be drawn from the following detailed description of the preferred embodiment and a preferred method of the present invention with the attached drawings, in which:

### BRIEF DESCRIPTION OF THE DRAWINGS

FIG. 1 is a schematic diagram of hardware and software infrastructure of a system for controlling favorite television channels with a single knob in accordance with the preferred embodiment of the present invention;

FIG. 2 is a flowchart of the preferred method for controlling favorite television channels with a single knob according to the present invention;

FIG. 3 is a flowchart of implementing one of steps of FIG. 2, namely updating viewing records of channels and sequencing the channels;

FIG. 4 is a flowchart of implementing another of the steps of FIG. 2, namely tuning to an immediately preceding (or a next) favorite channel; and

FIG. 5 is a flowchart of implementing still another of the steps of FIG. 2, namely automatically setting or deleting a favorite channel.

### DETAILED DESCRIPTION OF THE PREFERRED EMBODIMENT

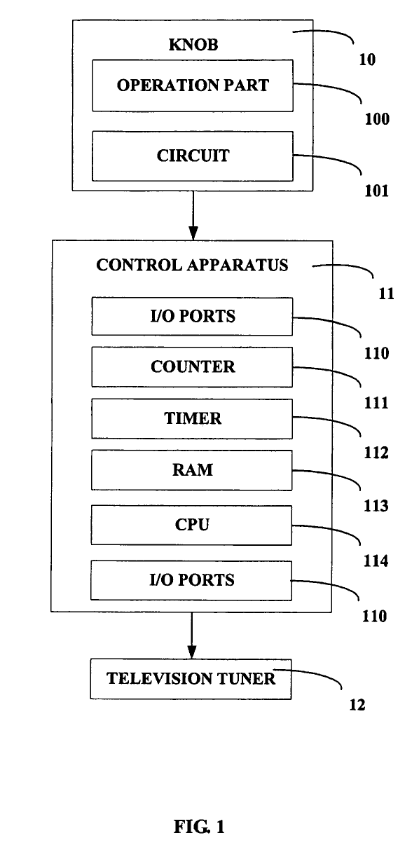

FIG. 1 is a schematic diagram of hardware and software infrastructure of a system for controlling favorite television channels with a signal knob (hereinafter “the system”) in accordance with the preferred embodiment of the present invention. The system includes a knob 10, a control apparatus 11, and a television tuner 12. The knob 10 is used for performing of press and rotational operations by users, and for generating press signals and rotation signals. The knob 10 includes an operation part 100 for performing the press and rotational operations, and a circuit 101 for generating corresponding press signals and rotation signals. A rotation signal includes a rotational direction signal and a rotation range signal. The rotation range signal is generated according to a number of continuous rotation pulses which indicate a range of a rotational operation. When the number of continuous rotation pulses generated by the circuit 101 is greater than or equal to a predetermined number of rotation pulses, the rotation range is regarded as a large one; otherwise, the rotation range is regarded as a small one. The control apparatus 11 is used for updating viewing records of channels according to a rotation signal, generating a channel-tuning signal according to the rotation signal, automatically selecting a favorite channel according to the updated viewing records of channels, and automatically setting or deleting a favorite channel according to a press signal. In the preferred embodiment, the channel-tuning signal is generated by the control apparatus 11, and may be an immediately preceding channel-tuning signal, a next channel-tuning signal, an immediately preceding favorite channel-tuning signal, or a next favorite channel-tuning signal, depending on a rotational direction and a rotation range of the rotation signal.

The control apparatus 11 includes a plurality of Input/Output (I/O) ports 110, a counter 111, a timer 112, a Random Access Memory (RAM) 113, and a Central Processing Unit (CPU) 114. The I/O ports 110 are used for receiving press signals and rotation signals from the knob 10, and outputting channel-tuning signals generated by the control apparatus 11 in order to control the television tuner 12. The counter 111 is used for counting a number of continuous pulses that the circuit 101 generates during a rotational operation. The timer 112 is used for timing a viewing time of a current channel. The RAM 113 is used for storing: a channel list; viewing records of channels in the channel list; a sequence of the channels according to their viewing records; and a plurality of predetermined parameters. The channel list includes channel identifiers and favoritism identifiers of the channels. The channel identifiers are used for differentiating the channels, and the favoritism identifiers are used for marking whether the channels have been automatically set as favorite ones. A value of “1” of a favoritism identifier of a channel means that the channel is an automatically set favorite channel, and a value of “0” means that the channel is not an automatically set favorite channel. The viewing records of the channels record each channel's view count, total viewing time, and view value. The view value of a channel is a calculated result based on the view count and total viewing time of the channel. The predetermined parameters include a predetermined number of pulses, a predetermined viewing time, and a predetermined parameter N that is used for determining whether a channel is included in automatically selected favorite channels.

The CPU 114 is used for updating viewing records of channels when receiving rotation signals, determining a rotational direction and a rotation range according to each rotation signal, generating corresponding channel-tuning signals, automatically selecting favorite channels according to the viewing records, and automatically setting and deleting favorite channels when receiving press signals. Each channel-tuning signal is generated by the CPU 114, and may be an immediately preceding channel-tuning signal, an immediately preceding favorite channel-tuning signal, a next channel-tuning signal, or a next favorite channel-tuning signal, depending on a rotational direction signal and a rotation range signal. The television tuner 12 is used for tuning the channels according to the channel-tuning signals generated by the control apparatus 11.

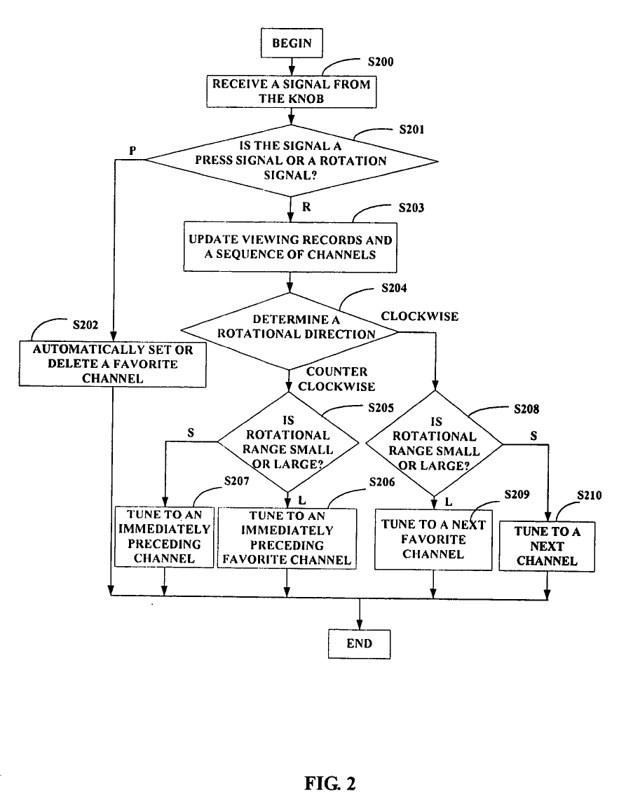

FIG. 2 is a flowchart of a preferred method for controlling favorite television channels with a single knob in accordance with the present invention. In step S200, the control apparatus 11 receives a signal from the knob 10. In step S201, the CPU 114 determines whether the knob signal is a rotation signal or a press signal. If the knob signal is a press signal, in step S202, the CPU 114 searches in a channel list stored in the RAM 113, and automatically sets or deletes a favorite channel by modifying the favoritism identifier of the current channel. Then the procedure is ended. If the knob signal is a rotation signal, in step S203, the CPU 114 updates viewing records and a sequence of channels. Updating the viewing records includes updating each channel's view count, total viewing time, and view value; the view value being a calculated result based on the channel's view count and total viewing time. In step S204, the CPU 114 determines a rotational direction according to the rotation signal. If the rotational direction is clockwise, the procedure goes to step S208 described below. If the rotational direction is counter-clockwise, in step S205, the CPU 114 determines whether the rotation range is large or small according to the rotation range signal. If the rotation range is large, in step S206, the CPU 114 generates an immediately preceding favorite channel-tuning signal, and controls the television tuner 12 to tune to an immediately preceding favorite channel, which is the next lowest favorite channel in numerical sequence relative to the current channel. If the rotation range is small, in step S207, the CPU 114 generates an immediately preceding channel-tuning signal, and controls the television tuner 12 to tune to the immediately preceding channel, which is the next lowest channel in numerical sequence relative to the current channel.

In step S208, the CPU 114 determines whether the rotation range is large or small according to the rotation range signal. If the rotation range is large, in step S209, the CPU 114 generates a next favorite channel-tuning signal, and controls the television tuner 12 to tune to the next favorite channel, which is the next highest favorite channel in numerical sequence relative to the current channel. If the rotation range is small, in step S210, the CPU 114 generates a next channel-tuning signal, and controls the television tuner 12 to tune to the next channel, which is the next highest channel in numerical sequence relative to the current channel.

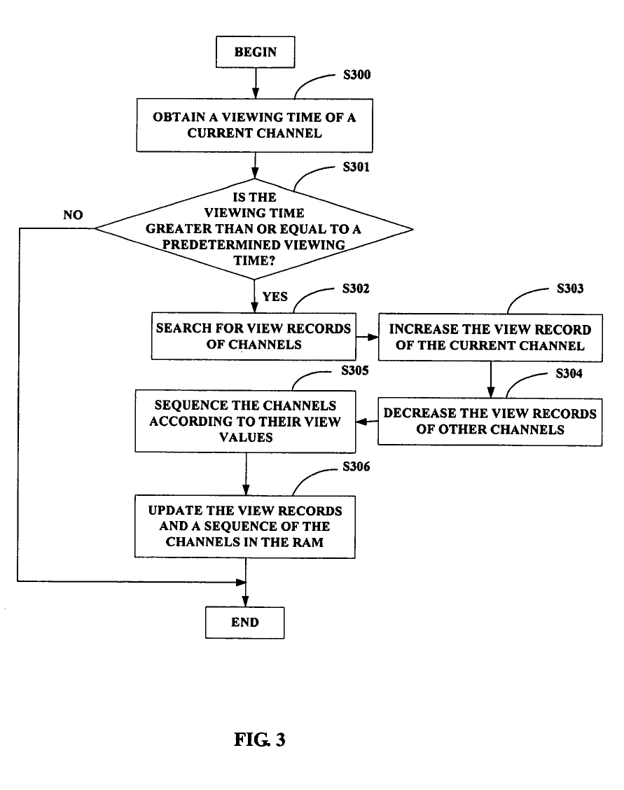

FIG. 3 is a flowchart of details of step S203 of FIG. 2, namely updating viewing records of channels and sequencing the channels according to the updated viewing records. The procedure starts when the control apparatus 11 receives a rotation signal or when the television powers off. In step S300, the CPU 114 obtains a viewing time of the current channel as timed by the timer 112. In step S301, the CPU 114 compares the viewing time of the current channel with a predetermined viewing time. If the viewing time is less than the predetermined viewing time, the procedure is ended. If the viewing time is greater than or equal to the predetermined viewing time, in step S302, the CPU 114 searches for the viewing records in the RAM 113. In step S303, the CPU 114 increases the view count, total viewing time and view value of the current channel. The increased view value of the current channel is calculated according to a formula based on two predetermined parameters “A” and “B.” The formula is: increased view value=A+B*the viewing time. In step S304, the CPU 114 decreases the view counts, total viewing times and view values of other channels. The decreased view value of each other channel is calculated according to a formula based on two predetermined parameters “C” and “D.” The formula is: decreased view value=C+D*the viewing time. In step S305, the CPU 114 sequences the channels according to their view values. In step S306, the CPU 114 updates the viewing records and the sequence of channels stored in the RAM 113 according to the new viewing records and the new sequence of channels.

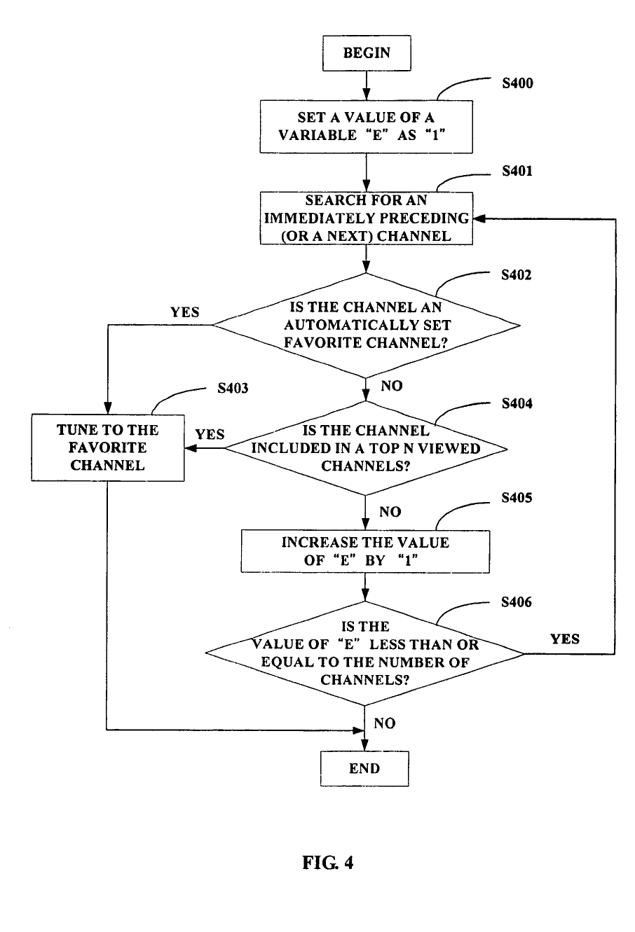

FIG. 4 is a flowchart of details of step 206 (or step S209) of FIG. 2, namely tuning to an immediately preceding (or a next) favorite channel. In step S400, the CPU 114 sets a value of a variable E as “1.” In the preferred embodiment of the present invention, the value of the variable E is to be increased in increments of “1,” and is used for indicating how many channels have been searched when searching for an immediately preceding (or a next) favorite channel. In step S401, the CPU 114 searches for an immediately preceding (or a next) channel according to channel identifiers which are stored in the channel list in the RAM 113. In step S402, the CPU 114 determines whether the immediately preceding (or the next) channel is an automatically set favorite channel according to its favoritism identifier. That is, the CPU 114 determines whether the value of the immediately preceding (or the next) channel's favoritism identifier is “1.” If the value of the immediately preceding (or the next) channel's favoritism identifier is “1,” in step S403, the CPU 114 generates an immediately preceding (or a next) favorite channel-tuning signal, and controls the tuner 12 to tune to the favorite channel, whereupon the procedure is ended. If the value of the immediately preceding (or the next) channel's favoritism identifier is “0,” in step S404, the CPU 114 determines whether the immediately preceding (or the next) channel is included in a top N viewed channels according to the sequence of channels which is stored in the RAM 113. If the immediately preceding (or the next) channel is included in the top N viewed channels, the procedure goes to step S403 described above. If the immediately preceding (or the next) channel is not included in the top N viewed channels, in step S405, the CPU 114 increases the value of the variable E by “1.” In step S406, the CPU 114 determines whether the value of the variable E is less than or equal to the number of channels in the channel list. That is, the CPU 114 determines whether all channels in the channel list have been searched. If the value of the variable E is less than or equal to the number of channels in the channel list, the procedure returns to step S401 described above. If the value of the variable E is greater than the number of channels in the channel list, the procedure is ended.

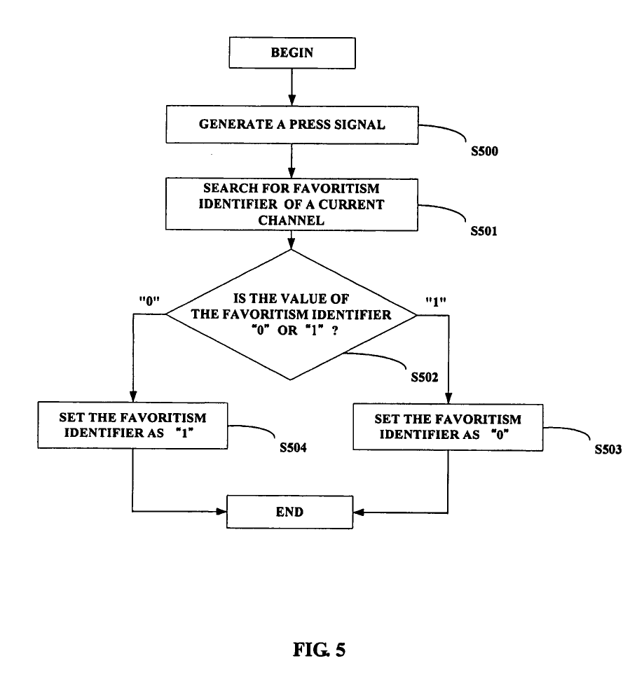

FIG. 5 is a flowchart of details of step S202 of FIG. 2, namely automatically setting or deleting a favorite channel by modifying the favoritism identifier of the current channel. In step S500, the knob 10 generates a press signal. In step S501, the CPU 114 searches for a favoritism identifier of the current channel in a channel list stored in the RAM 113. In step S502, the CPU 114 determines whether the current channel is an automatically set favorite channel or is a non-favorite channel, according to the favoritism identifier of the current channel. That is, the CPU 114 determines whether the value of the favoritism identifier of the current channel is “1” or “0.” If the current channel is an automatically set favorite channel, in step S503, the CPU 114 changes the value of the favoritism identifier from “1” to “0.” If the current channel is a non-favorite channel, in step S504, the CPU 114 changes the value of the favoritism identifier from “0” to “ 1.”

Although the present invention has been specifically described on the basis of a preferred embodiment and a preferred method, the invention is not to be construed as being limited thereto. Various changes and modifications may be made to the embodiment and method without departing from the scope and spirit of the invention.

1. A system for controlling favorite television channels with a single knob, the system comprising:
a knob for generating press signals and rotation signals;
a control apparatus for generating channel-tuning signals and updating viewing records of channels according to the rotation signals, automatically selecting favorite channels according to the viewing records and automatically setting and deleting favorite channels according to the press signals; and
a television tuner for tuning channels according to the channel-tuning signals generated by the control apparatus.

2. The system according to claim 1, wherein the control apparatus comprises a Central Processing Unit (CPU) for generating the channel-tuning signals and updating the viewing records of the channels according to the rotation signals.

3. The system according to claim 2, wherein the CPU is further used for automatically selecting favorite channels according to the viewing records.

4. The system according to claim 2, wherein the CPU is further used for automatically setting and deleting favorite channels according to the press signals.

5. The system according to claim 1, wherein the control apparatus further comprises a counter for counting continuous rotation pulses generated by the knob during a rotational operation.

6. The system according to claim 1, wherein the control apparatus further comprises a timer for timing a viewing time of a current channel.

7. The system according to claim 1, wherein the control apparatus further comprises a Random Access Memory (RAM) for storing a channel list, viewing records of the channels, and a plurality of predefined parameters.

8. The system according to claim 7, wherein the channel list is used for recording channel identifiers and favoritism identifiers of the channels.

9. The system according to claim 7, wherein the predefined parameters comprise a predetermined viewing time and a predetermined parameter N, the predetermined parameter N being used for determining whether a channel is included in automatically selected favorite channels.

10. A method for controlling favorite television channels with a single knob, the method comprising the steps of:
receiving a knob signal;
determining whether the knob signal is a press signal or a rotation signal;
setting or deleting a favorite channel by modifying a favoritism identifier of a current channel if the knob signal is a press signal;
updating viewing records of channels and sequencing the channels according to their viewing records if the knob signal is a rotation signal;
determining whether a rotation range of the rotation signal is large or small;
tuning to a favorite channel if the rotation range is large; and
tuning to an immediately preceding or a next channel if the rotation range is small.

11. The method according to claim 10, wherein the step of updating viewing records of channels and sequencing the channels comprises the steps of:
determining whether a viewing time of the current channel is greater than or equal to a predefined viewing time;
increasing the viewing record of the current channel and decreasing the viewing records of the other channels if the viewing time of the current channel is greater than or equal to the predefined viewing time;
sequencing the channels according to the new viewing records of the channels; and
updating the viewing records and the sequence of the channels stored in an electronic memory.

12. The method according to claim 10, wherein the step of tuning to a favorite channel comprises the steps of:
searching for an immediately preceding (or a next) channel in the channel list;
determining whether the immediately preceding (or next) channel is an automatically set favorite channel;
tuning to the favorite channel if the immediately preceding (or next) channel is an automatically set favorite channel;
determining whether the immediately preceding (or next) channel is included in a top N viewed channels according to a sequence of the channels if the immediately preceding (or next) channel is not an automatically set favorite channel;
tuning to the favorite channel if the immediately preceding (or next) channel is included in the top N viewed channels;
determining whether all channels in the channel list have been searched if the channel is not included in the top N viewed channels; and
returning to the step of searching for an immediately preceding (or a next) channel in the channel list if all the channels in the channel list have not been searched.

13. The method according to claim 11, wherein the step of setting or deleting a favorite channel by modifying the favoritism identifier of the current channel comprises setting a value of the favoritism identifier of the current channel as “1” or “0.”

14. A method of controlling favorite entertainment channels with a single knob, comprising steps of:
providing a knob with two-way rotation and pressing movabilities thereof;
categorizing all available channels with mutually exclusively a favorable type and an unfavorable type; wherein
clockwise and counterclockwise rotations of said knob mutually exclusively look for one of proceeding and next available channels;
quick and slow rotations of said knob mutually exclusively look for one of the recognized favorable and unfavorable channels; and
pressing movement of said knob switches the types of the channel between the favorable type and the unfavorable type.
